(19) United States
(12) Patent Application Publication
(10) Pub. No.: US 2026/0113658 A1
(43) Pub. Date: Apr. 23, 2026

(54) DYNAMIC BSR TABLES FOR UPLINK BUFFER SIZE ESTIMATION

(71) Applicant: Nokia Technologies Oy, Espoo (FI)

(72) Inventors: Boyan YANAKIEV, Aalborg (DK); Carlos Santiago MOREJON GARCIA, Aalborg (DK); Klaus PEDERSEN, Aalborg (DK); Abolfazl AMIRI, Aalborg (DK); Benoist SEBIRE, Tokyo (JP)

(21) Appl. No.: 19/114,004

(22) PCT Filed: Sep. 29, 2022
(86) PCT No.: PCT/US2022/045164

§ 371 Date: Mar. 21, 2025

(51) Int. Cl. H04W 28/02

(52) U.S. Cl. CPC H04W 28/0278; H04W 28/0257

(57) ABSTRACT

An apparatus including at least one processor, and at least one non-transitory memory including computer program code, the at least one memory and the computer program code configured to, with the at least one processor, cause the apparatus to perform: receiving a signal including information configured to be used for partially or entirely changing a changeable buffer status report table; and changing the changeable buffer status report table based upon the received information.

### BACKGROUND

### Technical Field

The example and non-limiting embodiments relate generally to wireless communication and, more particularly, to a buffer status report table.

### BRIEF DESCRIPTION OF PRIOR DEVELOPMENTS

Use of buffer status report (BSR) tables with wireless communication is known. It is supported in both LTE and NR standards for optimizing the UL resource usage by the network. This mechanism allows the network to allocate UL resources (UL Grant) only when the UE has something to transmit and attempt to limit the amount of over-allocation.

An example of UL traffic models for extend reality (XR) services are defined in TR 38.838. An example of the formats for the BSR reporting by a UE are specified, in section 6.1.3.1 of 3GPP TS 38.321. As noted in that section:

Buffer Size: The Buffer Size field identifies the total amount of data available according to the data volume calculation procedure in TS 38.322 [3] and 38.323 [4] across all logical channels of a logical channel group after the MAC PDU has been built (i.e. after the logical c prioritization procedure, which may result the value of the Buffer Size field to zero). The amount of data is indicated in number of bytes. The size of the RLC and MAC headers are not considered in the buffer size computation. The length of this field for the Short BSR format and the Short Truncated BSR format is 5 bits. The length of this field for the Long BSR format and the Long Truncated BSR format is 8 bits. The values for the 5-bit and 8-bit Buffer Size fields are shown in Tables 6.1.3.1-1 and 6.1.3.1-2, respectively. For the Long BSR format and the Long Truncated BSR format, the Buffer Size fields are included in ascending order based on the LCGi. For the Long Truncated BSR format the number of Buffer Size fields included is maximised, while not exceeding the number of padding bits. NOTE: The number of the Buffer Size fields in the Long BSR and Long Truncated BSR format can be zero.

### SUMMARY

The following summary is merely intended to be an example. The summary is not intended to limit the scope of the claims.

In accordance with one aspect, an example apparatus is provided comprising: at least one processor; and at least one non-transitory memory including computer program code, the at least one memory and the computer program code configured to, with the at least one processor, cause the apparatus to perform: receiving a signal comprising information configured to be used for partially or entirely changing a changeable buffer status report table; and changing the changeable buffer status report table based upon the received information.

In accordance with another aspect, an example apparatus is provided comprising: at least one processor; and at least one non-transitory memory including computer program code, the at least one memory and the computer program code configured to, with the at least one processor, cause the apparatus to perform: receiving a signal comprising parameters configured to be used for creating a changeable buffer status report table, where at least one of the parameters is configured to be used to at least partially determine a bin pattern for the changeable buffer status report table; and creating the changeable buffer status report table based, at least partially, upon the received signal.

In accordance with another aspect, an example apparatus is provided comprising: at least one processor; and at least one non-transitory memory including computer program code, the at least one memory and the computer program code configured to, with the at least one processor, cause the apparatus to perform: determining that a changeable buffer status report table has an accuracy below a predetermined threshold; based upon the determining that the changeable buffer status report table has an accuracy below the predetermined threshold, transmitting information to indicate that the changeable buffer status report table has the accuracy below the predetermined threshold.

In accordance with another an example apparatus is provided comprising: at least one processor; and at least one non-transitory memory including computer program code, the at least one memory and the computer program code configured to, with the at least one processor, cause the apparatus to perform: determining that a changeable buffer status report table has an accuracy below a predetermined threshold; based upon the determining that the changeable buffer status report table has an accuracy below the predetermined threshold, transmitting information to indicate that the changeable buffer status report table has the accuracy below the predetermined threshold.

In accordance with another aspect, an example apparatus is provided comprising: at least one processor; and at least one non-transitory memory including computer program code, the at least one memory and the computer program code configured to, with the at least one processor, cause the apparatus to perform: receiving at least one signal comprising parameters configured to be used for creating a plurality of buffer status report tables; creating the plurality of buffer status report tables based upon the received at least one signal; and selectively using one or more of the created buffer status report tables for buffering a first information.

In accordance with another aspect, an example apparatus is provided comprising: at least one processor; and at least one non-transitory memory including computer program code, the at least one memory and the computer program code configured to, with the at least one processor, cause the apparatus to perform: transmitting a signal to a user equipment over a MAC control element with information configured to be used to partially or entirely change a changeable buffer status report table in the user equipment.

In accordance with another aspect, an example apparatus is provided comprising: at least one processor; and at least one non-transitory memory including computer program code, the at least one memory and the computer program code configured to, with the at least one processor, cause the apparatus to perform: receiving protocol data unit session information; based, at least partially, on the received data unit session information, determining a plurality of parameters, where at least one of the parameters is configured to be used to at least partially determine a bin pattern for a changeable buffer status report table; using the plurality of parameters to create the changeable buffer status report table.

In accordance with another aspect, an example apparatus is provided comprising: at least one processor; and at least one non-transitory memory including computer program code, the at least one memory and the computer program code configured to, with the at least one processor, cause the apparatus to perform: receiving protocol data unit session information; based, at least partially, on the received data unit session information, determining a plurality of parameters, where at least one of the parameters is configured to be used to at least partially determine a bin pattern for a changeable buffer status report table; and based, at least partially, on the received data unit session information, sending to a user equipment the parameters with a radio resource control message.

In accordance with another aspect, an example apparatus is provided comprising: at least one processor; and at least one non-transitory memory including computer program code, the at least one memory and the computer program code configured to, with the at least one processor, cause the apparatus to perform: receiving a signal from a user equipment indicating that a changeable buffer status report table does not meet an accuracy requirement; and based upon the receiving of the signal, sending information to the user equipment configured for changing the changeable buffer status report table in the user equipment.

In accordance another aspect, an example with apparatus is provided comprising: at least one processor; and at least one non-transitory memory including computer program code, the at least one memory and the computer program code configured to, with the at least one processor, cause the apparatus to perform: receiving protocol data unit session information; creating a plurality of changeable buffer status report tables; and selectively using one or more of the created changeable buffer status report tables in regard to a first information buffered and sent by a user equipment.

In accordance with another aspect, an example apparatus is provided comprising: at least one processor; and at least one non-transitory memory including computer program code, the at least one memory and the computer program code configured to, with the at least one processor, cause the apparatus to perform: selecting a plurality of buffer status reports so that the sum of buffer sizes reported for the plurality of buffer status reports is more accurate than the buffer size indicated by a single one of the buffer status reports.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting exemplary system in which the exemplary embodiments may be practiced;

FIG. 2 is a figure from section 6.1.3.1 of 3GPP TS 38.321;

FIG. 3 is a figure from section 6.1.3.1 of 3GPP TS 38.321;

FIG. 4 is a figure from section 6.1.3.1 of 3GPP TS 38.321;

FIGS. 5A-5B (collectively FIG. 5) is a figure from section 6.1.3.1 of 3GPP TS 38.321;

FIG. 6 is a diagram illustrating how a traffic model is mapped over BSR table bins for the table shown in FIG. 4;

FIG. 7 is a diagram illustrating how a traffic model is mapped over BSR table bins for the table shown in FIGS. 5A and 5B;

FIG. 8 diagram illustrating an example is a embodiment;

FIG. 9 is a diagram similar to FIG. 6 illustrating how a traffic model is mapped over BSR table bins with a range limited function for 5 bit BSR;

FIG. 10 is a diagram similar to FIG. 7 illustrating how a traffic model is mapped over BSR table bins with a range limited function for 8 bit BSR;

FIG. 11 is a diagram similar to FIG. 9 illustrating how a traffic model is mapped over BSR table bins with a probabilistic function for 5 bit BSR;

FIG. 12 is a diagram similar to FIG. 10 illustrating how a traffic model is mapped over BSR table bins with probabilistic function for 8 bit BSR;

FIG. 13 is a diagram illustrating CDF of the quantization error for 5 bit BSR tables including a reference, a truncated uniform linear and a truncated probabilistic;

FIG. 14 is a diagram illustrating CDF of the quantization error for 8 bit BSR tables including a reference, a truncated uniform linear and a truncated probabilistic;

FIGS. 15 and 16 generally illustrate that there may be different size buffer status report tables created by different parameters;

FIGS. 17 and 18 generally illustrate that values in different buffer status report tables may have different shapes such as linear and non-linear for example;

FIG. 19 illustrates that the UE may have multiple different buffer status report tables which may be selected and selectively used;

FIG. 20 is a diagram illustrating one example method;

FIG. 21 is a diagram illustrating one example method;

FIG. 22 is a diagram illustrating one example method;

FIG. 23 is a diagram illustrating one example method;

FIG. 24 is a diagram illustrating one example method;

FIG. 25 is a diagram illustrating one example method;

FIG. 26 is a diagram illustrating one example method;

FIG. 27 is a diagram illustrating one example method;

FIG. 28 is a diagram illustrating one example method;

FIG. 29 is a diagram illustrating one example method.

### DETAILED DESCRIPTION

The following abbreviations that may be found in the specification and/or the drawing figures are defined as follows:
3GPP third generation partnership project
5G fifth generation
5GC 5G core network
AMF access and mobility management function
AR Augmented reality
BSR Buffer Status Report
CDF Cumulative Distribution Function
CE Control Element
CN Core Network
CU central unit
DC dual connectivity
DL Downlink
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
fps Frames per second
gNB (or gNodeB) base station for 5G/NR, i.e., a node providing NR user plane and control plane protocol terminations towards the UE, and connected via the NG interface to the 5GC
I/F interface
KP Key performance indicator
LCG Logical channel group
LCH Logical Channel
LTE long term evolution
MAC medium access control
MME mobility management entity
MR Mixed reality
ng or NG new generation
ng-eNB or NG-eNB new generation eNB
NR new radio
N/W or NW network
PDB Packet delay budget
PDCCH Physical downlink control channel
PDSCH Physical downlink shared channel
PDU Protocol Data Unit
PHY physical layer
Qos Quality of service
RAN radio access network
Rel release
RLC radio link control
RRC radio resource control
RU radio unit
Rx receiver
SI Study Item
SID Study Item Description
SGW serving gateway
SMF session management function
TS technical specification
TTI transmission time interval
Tx transmitter
UE user equipment (e.g., a wireless, typically mobile device)
UPF user plane function
UL Uplink
VR Virtual reality
WI Work Item
XR Extended reality

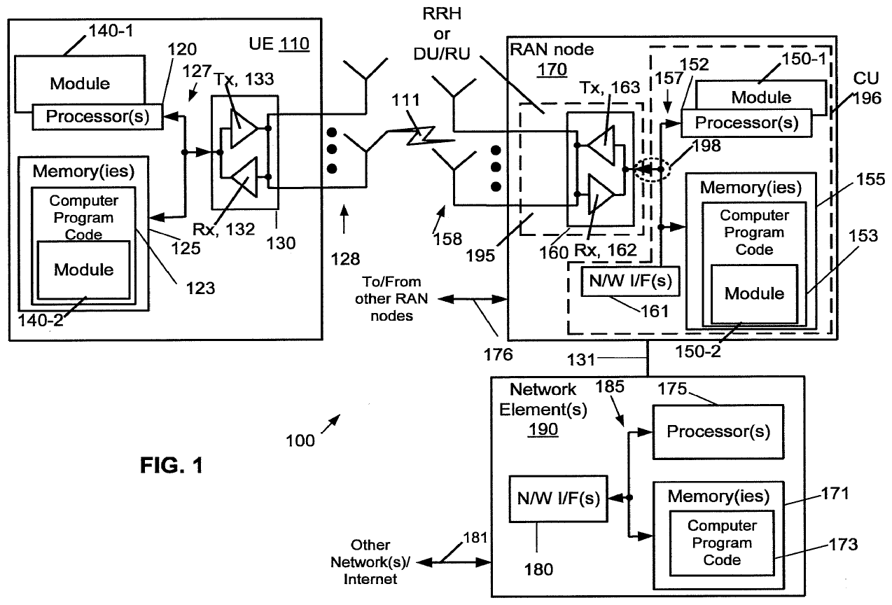

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still: implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

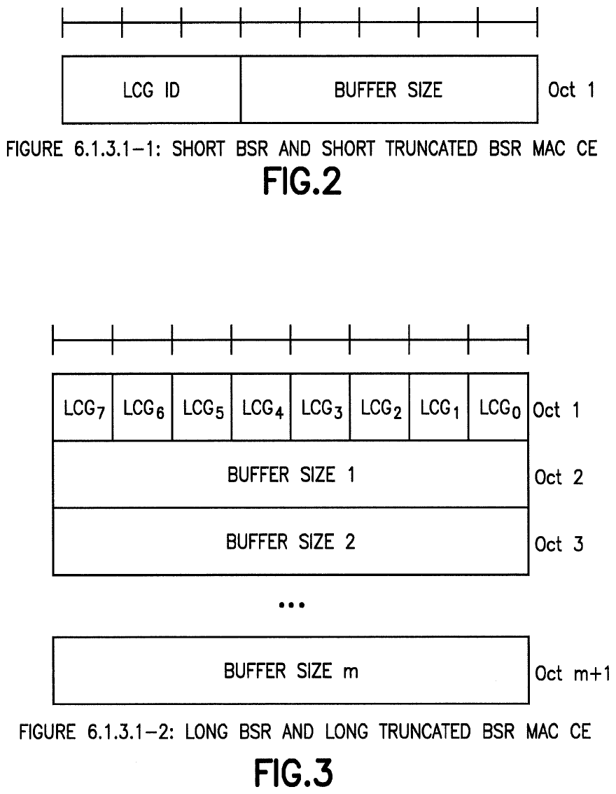

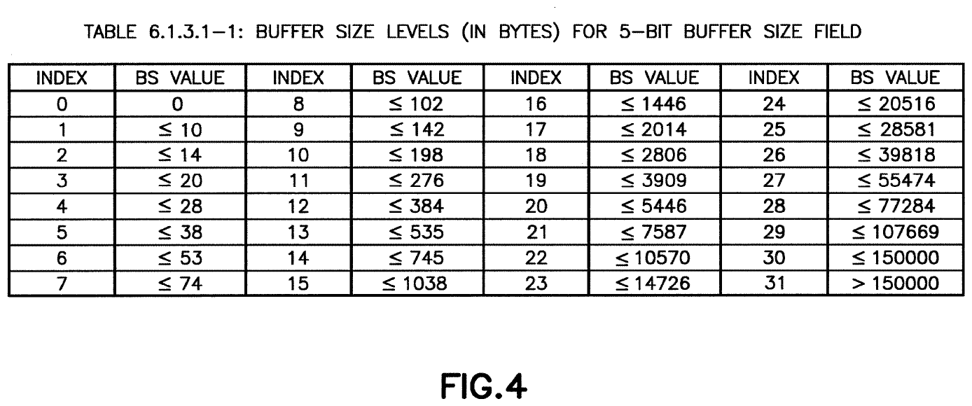

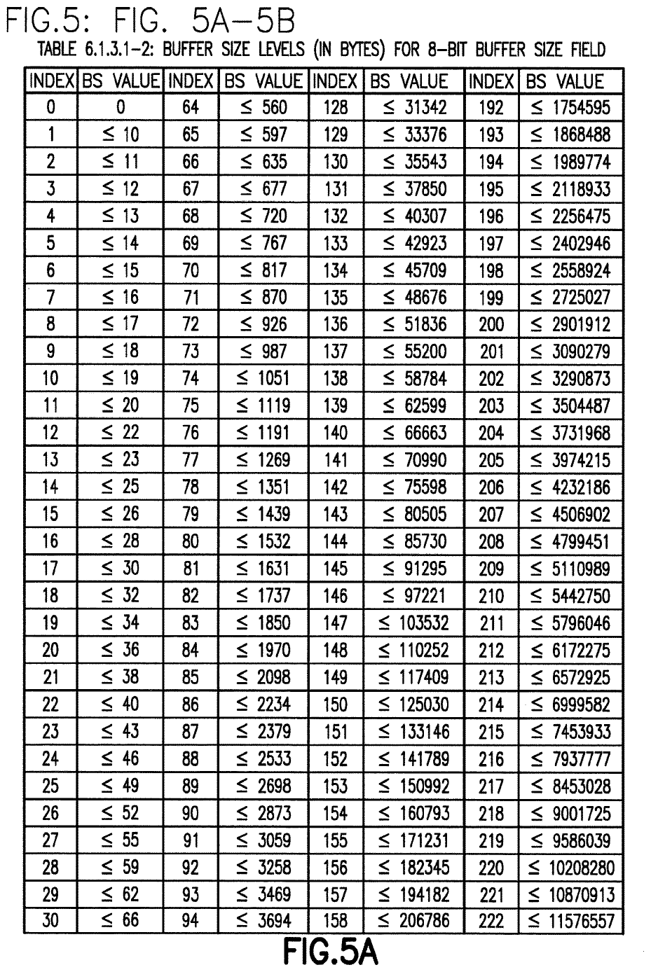

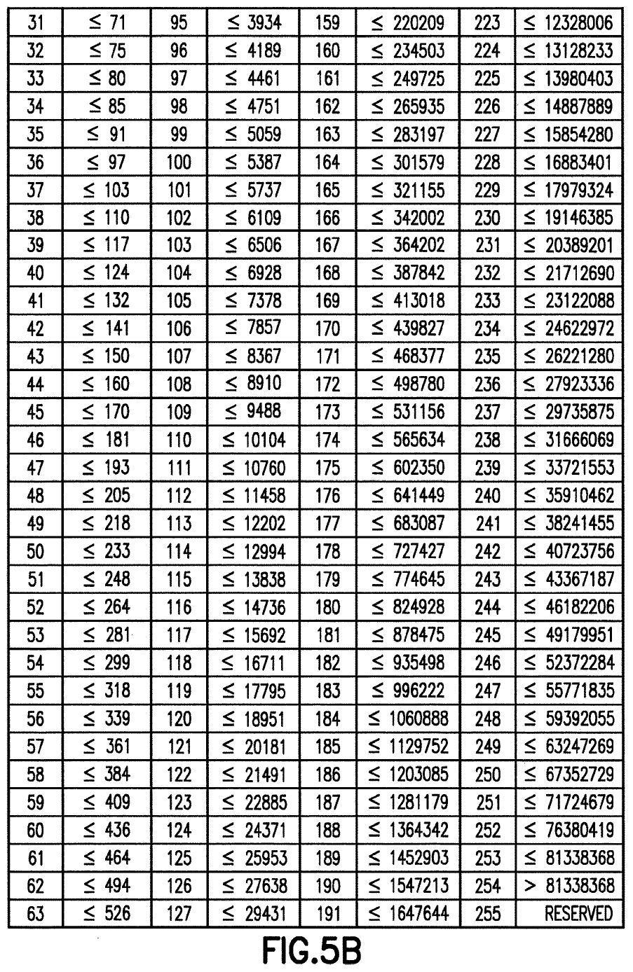

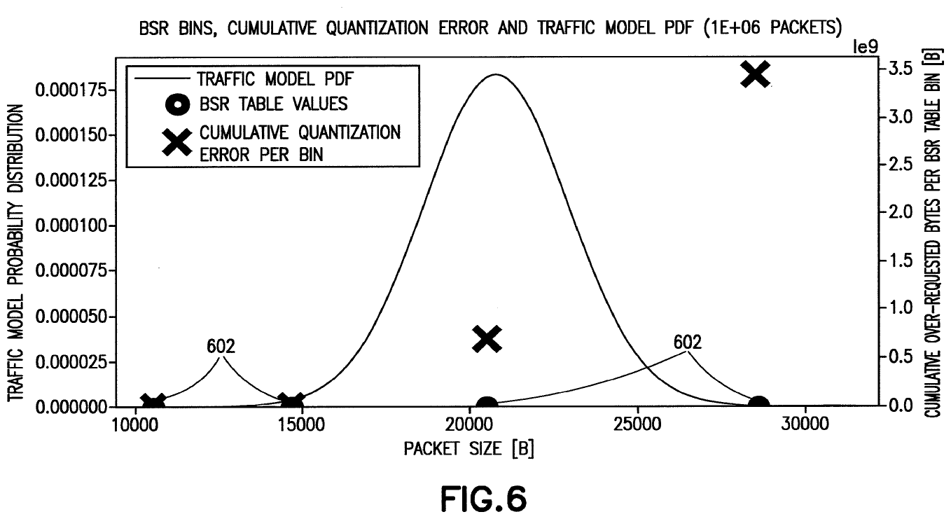

As noted above, a BSR (Buffer Status Report) carries information in regard to how much data is in a user equipment (UE) buffer to be sent out. It is supported in both LTE and NR standards for optimizing the UL resource usage by the network. This mechanism allows the network to allocate UL resources (UL Grant) only when the UE has something to transmit, and attempt to limit the amount of over-allocation. The network can indicate how much resources is allocated. However, there is some uncertainty in regard to how much resources should be allocated by the base station to be more accurate regarding resource allocation. This is because the buffer size of the BSR MAC CE is only 5 or 8 bits long and, instead of reporting actual bytes in the buffer, and the UE uses pre-defined tables, such as shown in FIGS. 4 and 5 for example) to match the actual BSR size to a BSR range. Thus, the base station only works with a range. The formats for the BSR reporting by the UE are specified, in section 6.1.3.1 of 3GPP TS 38.321, which include the Figures 6.1.3.1-1 and 6.1.3.1-2 of section 6.1.3.1 shown in FIGS. 2 and 3, and Tables 6.1.3.1-1 and 6.1.3.1-2 shown in FIGS. 4 and 5A-5B (collectively FIG. 5). Please note that these figures and tables are merely shown and described as examples and should not be considered as limiting.

The currently standardized BSR solution for NR rely on fixed generic BSR tables that are designed to cover a large set of use cases. This means that a compromise is made on the resolution and corresponding quantization errors for BSR. If the reported BSR such as, for example, indicate a too low buffer amount (due to the resolution of the BSR table), the gNB will schedule a too small transport block size (TBS) for the UE and, hence, will afterwards needs to schedule the UE again to have the rest of the buffered data transmitted to the gNB. This results in lower uplink throughput and increased latency. High uplink throughput and low latency are critical for XR use cases. If the BSR indicate more buffered data than actually buffered in the UE, the UE may have to apply zero padding if the gNB schedule the UE with a TBS in line with the BSR. This maps to decreased spectral efficiency (from using zero padding). Features as describe herein may be used to derive an enhanced BSR scheme, where effect of quantization errors from BSR (tables) are further minimized to improve the overall link and system level performance for the uplink. A flexible approach may be used that is applicable for diverse set of use cases, including a broad set of XR applications that range from low to high uplink data rates, different packet arrival rates, etc.

In the following we give some more examples of BSR quantization errors as additional background. In all cases 10 Mbps at 60 frames per seconds is considered following the truncated gaussian distribution defined in Table 5.5.2.1-1 of TS 38.838. A few basic parameters for this traffic model are:
Mean packet size: 20833 bytes
Minimum packet size: 10416 bytes
Maximum packet size: 31250 bytes.
Standard deviation (because, for generating the model, the normal distribution “shoulders” would be higher or lower depending on the standard deviation).
1 million packets have been used for evaluation

These simple numbers already indicate that the tables defined in TS 38.321 will be sub-optimally used as only a small number of the defined bins would ever be used leading to large quantization over-estimates.

Example: Assuming reporting via the 5 bit BSR table from Table 6.1.3.1-1 in TS 38.321, the above traffic model results in only a few of the BSR table bins being used. FIG. 6 shows how the traffic model mapped over the BSR table bins. Please note that for FIG. 6 only the bins from the table that are used for the traffic model given are shown. The other bins (the bins which are not used for the traffic model given) were clipped out or not included when plotting FIG. 6. The dots 602 indicate the BSR table bin boundaries. The X marks indicate the cumulative over-requested bytes per bin (quantization error). The shaded areas under the traffic model curve indicate the probability. It is clear that most bins have zero (0) probability of ever being used. Assuming a scheme, where the UE always rounds up and reports the larger BSR value using padding, then 16.7% of all requested bytes are padding bytes. Table values falling outside the traffic model packet sizes are not shown.

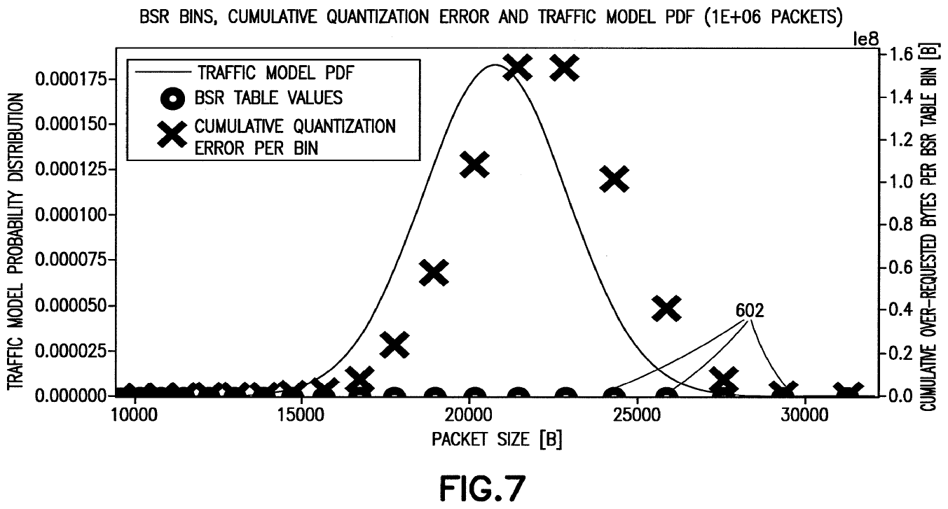

Using the larger, finer granularity 8 bit table improves things a bit. The padding bytes are significantly lower at 3.1% of the total requested bytes. FIG. 7 shows the results for an 8 bit BSR table utilization with the same interpretation as FIG. 6. FIG. 7 has a limited X axis to the maximum of the traffic model and all unused bins above are not shown. This is also true for the other similar figures with changeable BSR tables; only the lowest value of 0 is cut out. They are, of course, zero (0) probable and unused by the defined XR traffic model.

The step size used in the current BSR table can increase exponentially as buffer size increases (e.g. up to several MBs). Large step sizes can have a negative impact on system capacity for XR applications. XR applications and their traffic are intrinsically different to each other and various XR services will evolve differently over time. Thus, as evident from herein, it would be more effective to introduce a mechanism in which tables are created addressing the needs of the specific service. The importance of the BSR enhancements has been discussed in 3GPP meetings.

With features as described herein, introduction of dynamic or changeable BSR tables may be provided. The network may signal parameters to the UE for auto-generation of BSR table(s) that are in line with traffic characteristics for the UE. Moreover, a signaling exchange in a BSR-Config field in a RRC message may be used to set up a new table type. Finally, a new MAC CE can also be introduced for high-speed BSR table adjustments without the need for LCG reconfiguration via RRC.

With features as described herein, the UE's servings cell gNB may configure the UE with a min value and a max value for the buffer size to be used in the BSR table. Moreover, the UE may also be configured with information that relates to the bin ranges of the BSR table. The bin pattern or configuration or range may include, for example, informing the UE whether the BSR table shall be linear, exponential, or some other form (i.e., shape). Based on the configuration, the UE may be configured to auto-generate the BSR table. With this, the auto-generated BSR table may fit to the UE's current traffic characteristics. This may be used to minimize the quantization errors of BSR reporting as compared to if using fixed generic BSR tables that are designed to cover large variety of use cases. The network (NW) (such as the gNb for example) may also auto-generate the BSR table such that both the UE and NW have the same understanding.

Note that the gNB may have information from the core network (CN) regarding the UE's traffic and Qos characteristics. So, the gNB may properly select parameters, such as the min, max, and shape for example, to be used for the BSR table that is most suitable to use for configuring the UE. The gNB may, for example, base the parameters on 5Q1 information, information on the average data rate, of the number of frames per second, jitter information, etc. For XR cases, it is already being discussed to have such information signaled to the gNB to facilitate better radio performance optimization in line with the actual traffic characteristics. With features as disclosed herein, improved uplink performance may be provided as the gNb will have more accurate information to conduct proper radio resource allocations for its users in line with what is actually buffered for pending transmissions at the terminals.

With features as disclosed herein, a new MAC CE (or a bit in the BSR MAC CE) can be introduced for the UE to flag a reported BSR for which the indicated value is not accurate enough (within a given or configured threshold). With this information the network may be configured to be careful in allocating resources in the following grant(s) and/or adjust the BS table according to the scheme explained above. In another example embodiment, having a failing BSR to meet some accuracy requirement in a TTI may trigger another BSR in the subsequent transmission. As another example embodiment, more than one BSR could be triggered for the same LCH/LCG in the same TTI so that the sum is as accurate as possible. For instance, assuming 80 bytes are buffered, but we can only indicate 10, 30, 50, 100; instead of signaling one BSR with 50, we could have two: one with 50 and another with 30.

More details regarding the proposal are provided below, corresponding to the signaling exchange to enable a dynamic or changeable BSR table. There are multiple levels in the protocol stack where these steps can be implemented. For the examples below it is assumed the existing MAC CEs for BSR are preserved and the BSR tables to be generated are either 5 bit or 8 bit so that existing BSR MAC CE signaling can remain unchanged. This, however, does not preclude defining additional MAC CEs in the future with more or less bits.

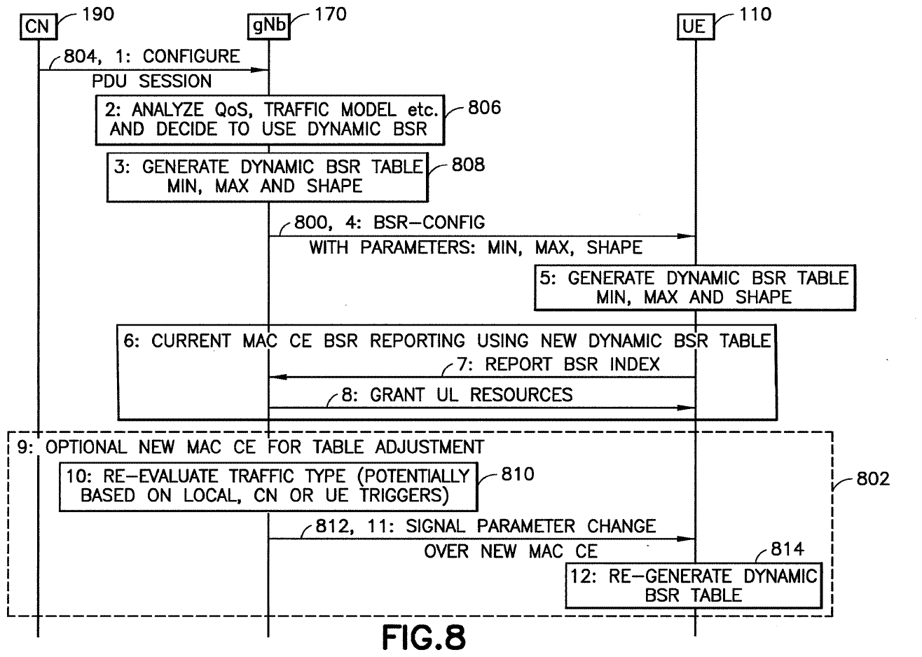

The example message signaling chart in FIG. 8 shows some of the steps in one type of example embodiment. FIG. 8 shows the example of a BSR-CONFIG message 800 sent from the gNB 170 to the UE 110. In this message 800 additional parameters are added, which are configured such that the UE has sufficient information to uniquely generate the new BSR table. As shown with step 9, an optional new MAC CE 802, configured for changing one or more of the parameters sent at step 4, is also possible for faster BSR table adjustment or re-writing. Such RRC (layer 3) in combination with MAC (layer 2) split is only one option. All signaling can also be done in MAC or RRC with various trade-offs to be considered.

At step 1 the CN 190 may provide PDU session information as indicated by 804. The PDU session information may contain expected traffic information. Supplying of PDU session information already exists in the current 5G specifications, but some traffic information details are not currently fully specified in the current 5G specifications. There are, however, multiple tracks within SA2 on standardizing such aspects. This can exact traffic model similar to the ones used in XR studies (for ex. 38.838) or simple XR flag indicating that the PDU session is an XR one and would be expected to see certain periodic traffic.

At step 2, the gNb may analyze the provided PDU session information and decide if there should be a dynamic BSR table(s) as indicated by 806, such as based on some identification or inference for example. At step 3, the gNB 170 may generate, as indicated by 808, a set of parameters which are configured to be used to generate the dynamic BSR table. These parameters include for example: minimum buffer size, maximum buffer size, and shape of the buffer as noted above. More or less parameters may be used. In step 4, the enhanced BSR-CONFIG message 800 may be sent, over an existing RRC signaling for example, informing the UE that a new BSR table may be or is being defined. The new fields in the BSR-CONFIG message 800 may carry the parameters needed to generate the new BSR table.

In one example embodiment, the gNB 170 uses the parameters to generate the new BSR table, and the UE also may use the parameters from message 800 to generate the same BSR table and use it for future BSR reports. So, both the gNB and the UE may separately generate the same BSR table based upon the parameters. Another example embodiment contemplates that in step 4 the gNB creates the new BSR table and transmits the new BSR table to the UE via RRC signaling rather than transmitting merely the parameters.

The UE 110 may wait to the next BSR reporting trigger (depending on the type of BSR), and measure the buffer size. The UE may report the index to the gNB over existing MAC CEs.

Another embodiment can be considered with different size MAC CEs and, therefore, larger tables. The gNB may use the reported index to schedule radio resources to the UE.

As indicated by step 9, an optional method may be provided, faster than RRC signaling, comprises change of table parameters is possible via a new MAC CE(s) 802. With this optional or additional method, one or more parameters defining the table can be updated based on traffic properties. Using the example of XR, this would be for example LAS marking on IP layer lowering the data rate—this marking rate and expected data rate based on it is known at the gNb and it can be beneficial to update the, for example, the min/max parameters of the table. As indicated by step 10 the gNB 170 may re-evaluate traffic type (potentially based on local, CN or UE triggers) as indicated by 810. At step 11, the gNB 170 may signal 812 a parameter change over the new MAC CE to the UE 110. At step 12, the UE 110 may be configured to use the information from signal 812 to re-generate 814 the dynamic BSR table in the UE to a new partially different BSR table.

### Example of Table Generation

Different strategies can be used to generate the new BSR table from a few defining parameters. Two examples are described below; namely, range limited function and probabilistic function. However, these example should not be considered as limiting. For these examples the same expected traffic model is used as the one described above. It is assumed in these examples that the existing 5 bit and 8 bit BSR reporting fields are used limiting the number of table entries. A few basic considerations for the tables are:
First element is always 0 (zero).
Last element is always interpreted as larger than the value.
Second to last element is the same as the last one, but interpreted as smaller than the value

Please note that the above is technically not required. It is simply bringing the tables in line with the existing ones, and provide some possibility to schedule any size traffic, albeit with much larger quantization error. The effect of this is that three of the table bins cannot be used for traffic adaptation.

### Range Limited Function

The range limited function may use the following parameters:
min_size: Expected minimum size of the buffer.
max_size: Expected maximum size of the buffer. This is mapped to the last 2 indexes of the new BSR table.
std: expected standard deviation of the distribution
lowerbound: This is the selected lower bound indicating the start of the linear limited range. This is defined in terms of Cumulative Distribution Function (CDF) probability for a buffer size to be below a given value.
upperbound: This is the selected upper bound indicating the stop of the linear limited range. This is defined in terms of CDF probability for a buffer size to be below a given value.
mean: Expected mean size of the buffer.
distribution: Expected distribution for the traffic-truncated gaussian in this example as for XR.

Procedure to calculate the BSR table:
1. Generate the distribution using min_size, max_size, mean and std
2. Calculate the value at lowerbound and then assign the newly calculated lower_limit to element 1 of the BSR table
3. Calculate the value at upperbound and then assign the newly calculated upper_limit to element N-3 of the BSR table
4. Calculate the BSR table step size as:

$$B S {R}_{s t e p} = \frac{upper\_limit - lower\_limit}{N - 3}$$

where N is the total number of BSR table entries (32 for 5 bit and 256 for 8 bit BSR field size)
5. Assign the BSR table values to the remaining bins by incrementing with BSRₛₜₑₚ starting from index 2.

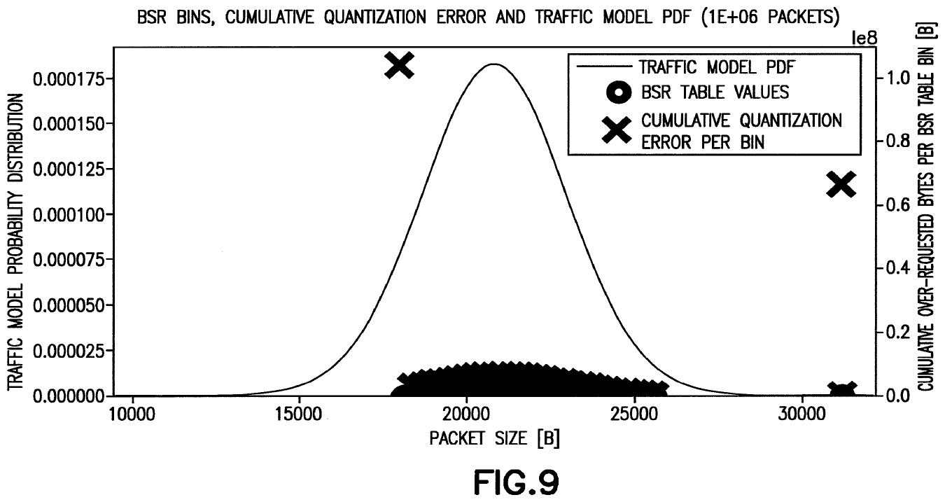

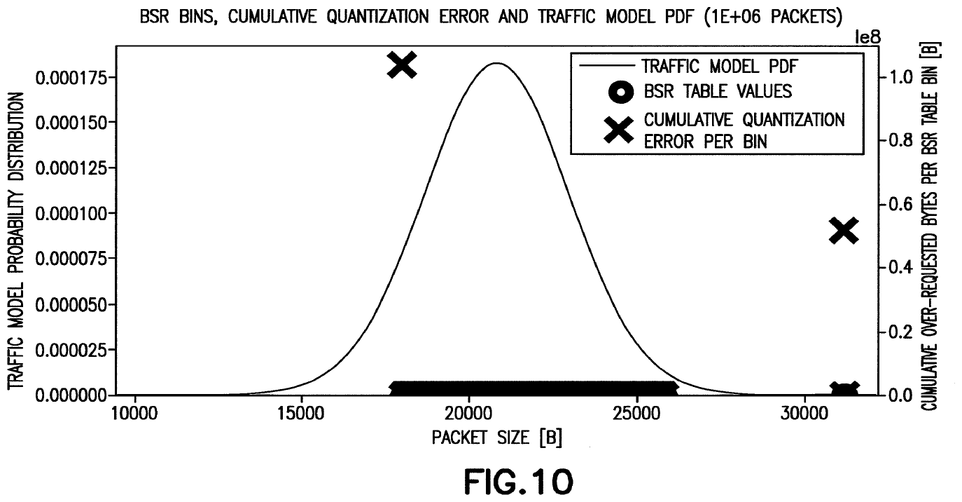

The performance of the scheme for lowerbound=0.1 and upperbound=0.99 (all other parameters are according to the traffic model) is shown in FIG. 9 for 5 bit BSR fields and FIG. 10 for 8 bit BSR fields. The corresponding erroneous over-requests are 1.4% and 0.8% compared to 16.7% and 3.1% for the current BSR tables respectively. It is also shown in the figures that the bulk of the over-requested bytes are from the first and last bins. Therefore, the scheme can be tuned by selecting a lower lowerbound and higher upperbound; increasing the over-request error in the middle, but lowering overall error rate.

### Probabilistic Function

The probabilistic function may use the following parameters:
min_size: Expected minimum size of the buffer. This is mapped to index 1 of the new BSR table.
max_size: Expected maximum size of the buffer. This is mapped to the last 2 indexes of the new BSR table.
std: Expected standard deviation of the distribution.
mean: Expected mean size of the buffer.
distribution: Expected distribution for the traffic-truncated gaussian in this example as for XR.

Procedure to calculate the BSR table:
1. Generate the distribution using min_size, max_size, mean and std
2. Calculate N-3 equiprobable ranges and assign them to the bins 2 to N-3. The calculation can be done for example using the quantile function.

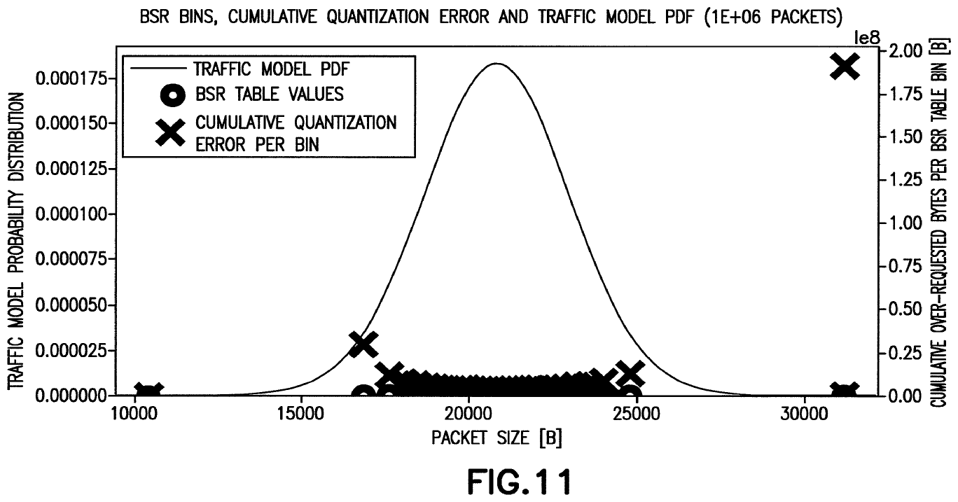

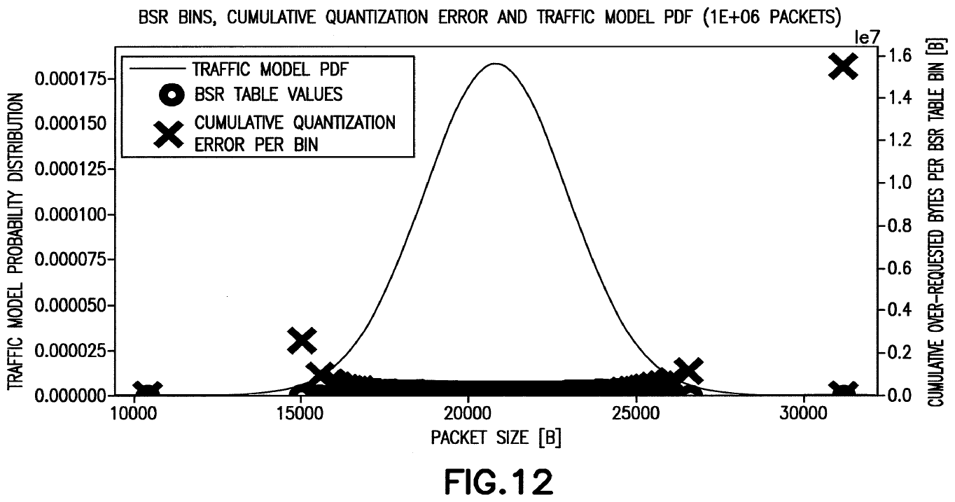

The performance of the scheme is shown in FIG. 11 for 5 bit BSR field and FIG. 12 for 8 bit BSR fields, respectively. The corresponding erroneous over-requests are 1.7% and 0.2% compared to 16.7% and 3.1% for the current BSR tables respectively. It is also shown in the figures that the bulk of the over-requested bytes are from the last bin. Therefore, the scheme can be tuned by skewing the distribution up or defining a range size to probability ratio; so that ranges are not equiprobably, but equal in terms of probability weighted with the size of the range.

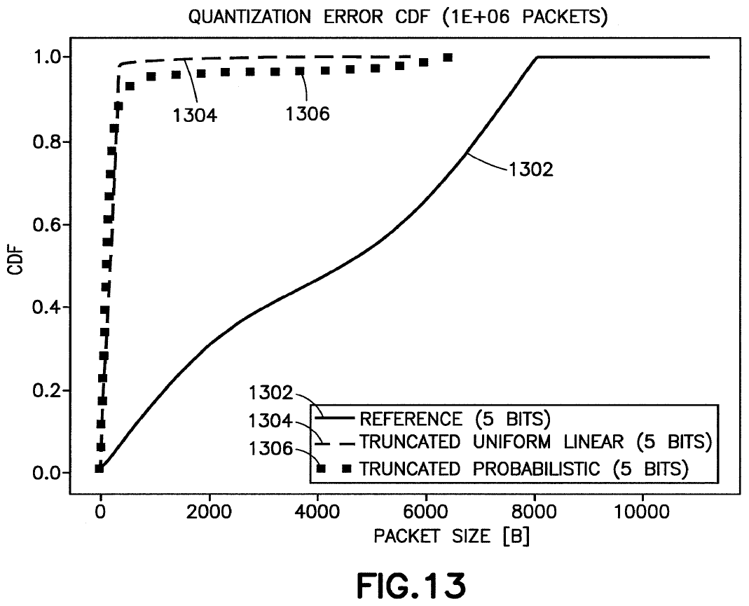

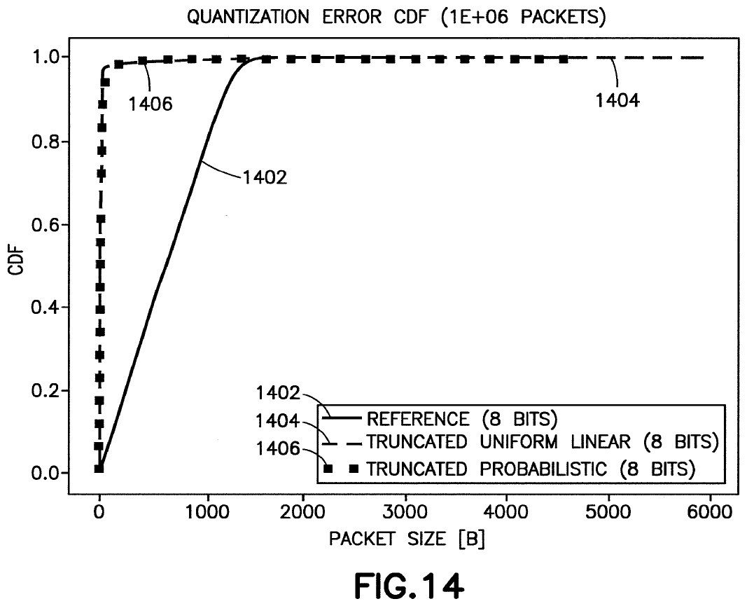

FIG. 13 summarizes the achieved improvement in terms of CDF of the quantization errors for 5 bit, and FIG. 14 summarizes the achieved improvement in terms of CDF of the quantization errors for 8 bit. FIGS. 13 and 14 show CDF versus packet size. In FIG. 13, for 5 bit, 1302 is a reference, 1304 is a truncated uniform linear and 1306 is a truncated probabilistic. In FIG. 14, for 5 bit, 1402 is a reference, 1404 is a truncated uniform linear and 1406 is a truncated probabilistic.

With features as described herein, a new MAC CE may be provided to adjust the tables. In addition, a new MAC CE (or a bit in the BSR MAC CE) can be introduced for the UE to flag a reported BSR for which the indicated value is not accurate enough (within a given or configured threshold); so that the network would be careful in allocating resources in the following grant(s) and/or adjust the BSR table according to the scheme explained above. Furthermore, having a BSR failing to meet some accuracy requirement in a TTI can be a trigger to trigger another BSR in the subsequent transmission. Specific gNB-to-UE signaling procedures may be provided such as, for example, pictured in FIG. 8. That may include having the gNB signaling specific parameters (such as min, max, and shape for example) to the UE, whereafter the UE may auto-generate the BSR table accordingly and it may be used afterwards.

Protocol data unit session information may comprise an indication for a changeable buffer status report table. Thus, a PDU session set up may carry specific instructions to use a changeable BSR. This is certainly one option. However, with features as described herein a PDU session may be set up as it is now, and circumstantial information contained in that set-up may be used to detect an opportunity for a changeable BSR, and the gNB may be configured to make a decision regarding using a changeable BSR on its own. The exact logic may be for gNB implementation. Additional PDU session signaling, to assist with that decision (or explicitly request it), is of course also options.

Finally, the gNB may also ignore all information in the PDU session set-up and simply run statistical analysis on the data going through and decide to act based on that regarding a possible changeable BSR.

New MAC CE signaling may be provided in at least following example specific cases:
Update changeable table defining parameters (implicitly triggering table re-definition)
Send indication of inaccurate BSR report-gNB actions based on that left for implementation
Send multiple BSR MAC CEs to build up a more accurate BSR knowledge at the gNB. Simplest example is to first under-report and then pad with second BSR report so that gNB uses the sum

More than one BSR could be triggered for the same LCH/LCG in the same TTI so that the sum is as accurate as possible. For instance, assuming 80 bytes are buffered but we can only indicate 10, 30, 50, 100; instead of signaling one BSR with 50, we could have two with 50 and 30.

In accordance with one example embodiment, an apparatus is provided comprising: at least one processor; and at least one non-transitory memory including computer program code, the at least one memory and the computer program code configured to, with the at least one processor, cause the apparatus to perform: receiving a signal comprising information configured to be used for partially or entirely changing a changeable buffer status report table; and changing the changeable buffer status report table based upon the received information.

The information may be configured to be used to only partially change the changeable buffer status report table. The information may comprise parameters configured to be used to change at least one value in the changeable buffer status report table or a size of the changeable buffer status report table or a shape of values in the changeable buffer status report table. The parameters may comprise information related to at least one of: a size of the changeable buffer status report table, a minimum value for a bin of the changeable buffer status report table, a maximum value for a bin of the changeable buffer status report table, a bin value pattern for the changeable buffer status report table, a value distribution shape for the changeable buffer status report table, whether the changeable buffer status report table is linear, or whether the changeable buffer status report table is exponential. The signal may comprise a BSR-CONFIG signal received from a base station. The changeable buffer status report table may comprise a plurality of bins, and where the at least one memory and the computer program code are configured to, with the at least one processor, cause the apparatus to create the changeable buffer status report table such that a value in at least one of the bins is configured to be changed without changing a value in at least one other one of the bins. The apparatus may perform receiving a MAC control element with further information configured to be used to partially change the changeable buffer status report table. The signal may comprise a MAC control element message.

In accordance with one example embodiment, a method may be provided as indicated in FIG. 20 comprising: receiving a signal by a user equipment comprising information configured to be used for partially or entirely changing a changeable buffer status report table as indicated by block 2002; and changing the changeable buffer status report table by the user equipment based upon the received information as indicated by block 2004. The information may be used by the user equipment to only partially change the changeable buffer status report table. The information may comprise parameters used to change the changeable buffer status report table. The parameters may comprise at least one of: a size of the changeable buffer status report table, a minimum value for a bin of the changeable buffer status report table, a maximum value for a bin of the changeable buffer status report table, a bin value pattern for the changeable buffer status report table, a value distribution shape for the changeable buffer status report table, whether the changeable buffer status report table is linear, or whether the changeable buffer status report table is exponential. The signal may comprise a BSR-CONFIG signal received from a base station. The changeable buffer status report table may comprise a plurality of bins, and where a value in at least one of the bins is changed without changing a value in at least one other one of the bins. The method may further comprise receiving a MAC control element with further information and using the further information to partially change the changeable buffer status report table. The signal may comprise a MAC control element message.

In accordance with one example embodiment, a non-transitory program storage device is provided readable by an apparatus, tangibly embodying a program of instructions executable with the apparatus for performing operations, the operations comprising: receiving a signal comprising information configured to be used for partially or entirely changing a changeable buffer status report table; and changing the changeable buffer status report table based upon the received information.

In accordance with one example embodiment, an apparatus is provided comprising: means for receiving a signal by a user equipment comprising information configured to be used for partially or entirely changing a changeable buffer status report table; and means for changing the changeable buffer status report table by the user equipment based upon the received information.

In accordance with one example embodiment, an apparatus is provided comprising: at least one processor; and at least one non-transitory memory including computer program code, the at least one memory and the computer program code configured to, with the at least one processor, cause the apparatus to perform: receiving a signal comprising parameters configured to be used for creating a changeable buffer status report table, where at least one of the parameters is configured to be used to at least partially determine a bin pattern for the changeable buffer status report table; and creating the changeable buffer status report table based, at least partially, upon the received signal.

The creating of the changeable buffer status report table may comprise creating the changeable buffer status report table such that a portion of the changeable buffer status report table is configured to be changed without changing another portion of the changeable buffer status report table. The parameters may be configured to be used to establish at least one value in the changeable buffer status report table or a size of the changeable buffer status report table or a shape of values relative to one another in the changeable buffer status report table. The parameters may comprise information related to at least one of: a size of the changeable buffer status report table, a minimum value for a bin of the changeable buffer status report table, a maximum value for a bin of the changeable buffer status report table, a bin value pattern for the changeable buffer status report table, a value distribution shape for the changeable buffer status report table, whether the changeable buffer status report table is linear, or whether the changeable buffer status report table is exponential. The signal may comprise a BSR-CONFIG signal received from a base station. The changeable buffer status report table may comprise a plurality of bins, and where the at least one memory and the computer program code are configured to, with the at least one processor, cause the apparatus to create the changeable buffer status report table such that a value in at least one of the bins is configured to be changed without changing a value in at least one other one of the bins. The at least one memory and the computer program code may be configured to, with the at least one processor, cause the apparatus to perform receiving a MAC control element with further information configured to be used to partially change the changeable buffer status report table.

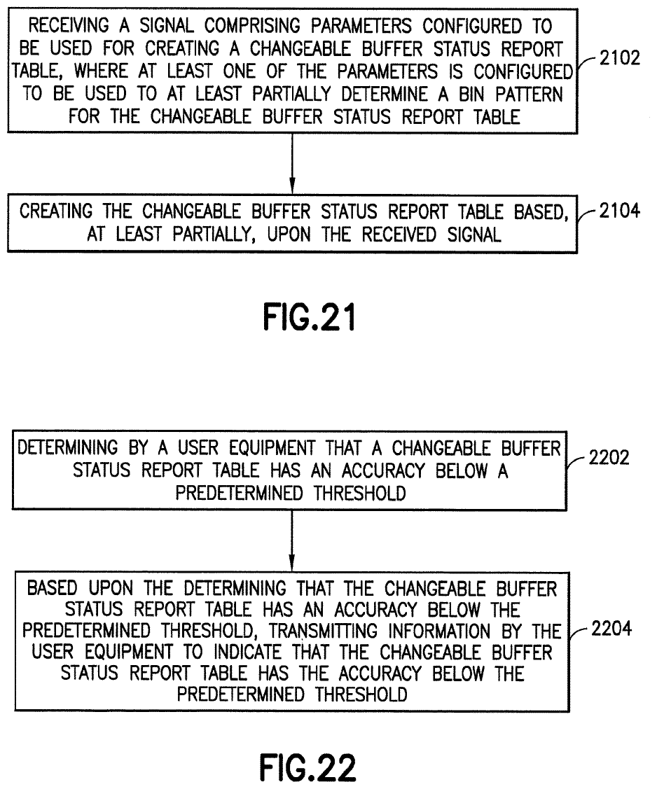

In accordance with one example embodiment, a method is provided as indicated by FIG. 21 comprising: receiving a signal comprising parameters configured to be used for creating a changeable buffer status report table, where at least one of the parameters is configured to be used to at least partially determine a bin pattern for the changeable buffer status report table as indicated by block 2102; and creating the changeable buffer status report table based, at least partially, upon the received signal as indicated by block 2104. The creating of the changeable buffer status report table may comprise creating the changeable buffer status report table such that a portion of the changeable buffer status report table is configured to be changed without changing another portion of the changeable buffer status report table. The parameters may be used to establish at least one value in the changeable buffer status report table or a size of the changeable buffer status report table or a shape of values relative to one another in the changeable buffer status report table. The parameters may comprise information related to at least one of: a size of the changeable buffer status report table, a minimum value for a bin of the changeable buffer status report table, a maximum value for a bin of the changeable buffer status report table, a bin value pattern for the changeable buffer status report table, a value distribution shape for the changeable buffer status report table, whether the changeable buffer status report table is linear, whether the changeable buffer status report table is exponential. The signal may comprise a BSR-CONFIG signal received from a base station. The changeable buffer status report table may comprise a plurality of bins, and where the changeable buffer status report table is created such that a value in at least one of the bins is configured to be changed without changing a value in at least one other one of the bins. The method may further comprise receiving a MAC control element with further information configured to be used to partially change the changeable buffer status report table.

In accordance with one example embodiment, a non-transitory program storage device is provided readable by an apparatus, tangibly embodying a program of instructions executable with the apparatus for performing operations, the operations comprising: receiving a signal by a user equipment comprising information configured to be used for partially or entirely changing a changeable buffer status report table; and changing the changeable buffer status report table by the user equipment based upon the received information.

In accordance with one example embodiment, an apparatus is provided comprising: means for receiving a signal by a user equipment comprising information configured to be used for partially or entirely changing a changeable buffer status report table; and means for changing the changeable buffer status report table by the user equipment based upon the received information.

In accordance with one example embodiment, an apparatus is provided comprising: at least one processor; and at least one non-transitory memory including computer program code, the at least one memory and the computer program code configured to, with the at least one processor, cause the apparatus to perform: determining that a changeable buffer status report table has an accuracy below a predetermined threshold; and based upon the determining that the changeable buffer status report table has an accuracy below the predetermined threshold, transmitting information to indicate that the changeable buffer status report table has the accuracy below the predetermined threshold.

The transmitting of the information to indicate that the changeable buffer status report table has an accuracy below the predetermined threshold may comprise a MAC control element transmitted by the apparatus to a base station. The transmitting of the information to indicate that the changeable buffer status report table has an accuracy below the predetermined threshold comprises a bit in a buffer status report MAC control element. The threshold may be one of: a threshold received by the apparatus or a threshold configured by the apparatus. The threshold may be in regard to a transmission time interval (TTI). The transmitted information may be configured to trigger sending of further information to partially change the changeable buffer status report table.

In accordance with one example embodiment, a method is provided as illustrated by FIG. 22 comprising: determining by a user equipment that a changeable buffer status report table has an accuracy below a predetermined threshold as indicated by block 2202; and based upon the determining that the changeable buffer status report table has an accuracy below the predetermined threshold, transmitting information by the user equipment to indicate that the changeable buffer status report table has the accuracy below the predetermined threshold as indicated by block 2404. The transmitting of the information to indicate that the changeable buffer status report table has an accuracy below the predetermined threshold may comprise a MAC control element transmitted by the apparatus to a base station. The transmitting of the information to indicate that the changeable buffer status report table has an accuracy below the predetermined threshold may comprise a bit in a buffer status report MAC control element. The threshold may be one of: a threshold received by the user equipment or a threshold configured by the user equipment. The threshold may be in regard to a transmission time interval (TTI). The transmitted information may be configured to trigger sending of further information to partially change the changeable buffer status report table.

In accordance with one example embodiment, a non-transitory program storage device is provided readable by an apparatus, tangibly embodying a program of instructions executable with the apparatus for performing operations, the operations comprising: determining that a changeable buffer status report table has an accuracy below a predetermined threshold; based upon the determining that the changeable buffer status report table has an accuracy below the predetermined threshold, transmitting information to indicate that the changeable buffer status report table has the accuracy below the predetermined threshold.

In accordance with one example embodiment, an apparatus is provided comprising: means for determining that a changeable buffer status report table has an accuracy below a predetermined threshold; and means for, based upon the determining that the changeable buffer status report table has an accuracy below the predetermined threshold, transmitting information to indicate that the changeable buffer status report table has the accuracy below the predetermined threshold.

In accordance with one example embodiment, an apparatus is provided comprising: at least one processor; and at least one non-transitory memory including computer program code, the at least one memory and the computer program code configured to, with the at least one processor, cause the apparatus to perform: receiving at least one signal comprising parameters configured to be used for creating a plurality of buffer status report tables; creating the plurality of buffer status report tables based upon the received at least one signal; and selectively using one or more of the created buffer status report tables for buffering a first information.

The creating of the plurality of buffer status report tables may comprise creating at least one changeable buffer status report table. The creating of the plurality of buffer status report tables may comprise the received at least one signal including information configured to be used for partially or entirely changing the at least one changeable buffer status report table; and the selectively using of the one or more created buffer status report tables comprises changing at least one of the changeable buffer status report tables based upon the received information. The parameters may be configured to be used to change, in at least one of the buffer status report tables: at least one value in the buffer status report table, or a size of the buffer status report table, or a shape of values relative to one another in the buffer status report table. The parameters may comprise information related to at least one of: a size of the changeable buffer status report table, a minimum value for a bin of the changeable buffer status report table, a maximum value for a bin of the changeable buffer status report table, a bin value pattern for the changeable buffer status report table, a value distribution shape for the changeable buffer status report table, whether the changeable buffer status report table is linear, whether the changeable buffer status report table is exponential. The at least one signal may comprise a BSR-CONFIG message received from a base station. The changeable buffer status report table may comprise a plurality of bins, and where the at least one memory and the computer program code are configured to, with the at least one processor, cause the apparatus to create the changeable buffer status report table such that a value in at least one of the bins is configured to be changed without changing a value in at least one other one of the bins. The at least one memory and the computer program code may be configured to, with the at least one processor, cause the apparatus to perform receiving a MAC control element with further information configured to be used to partially change the changeable buffer status report table.

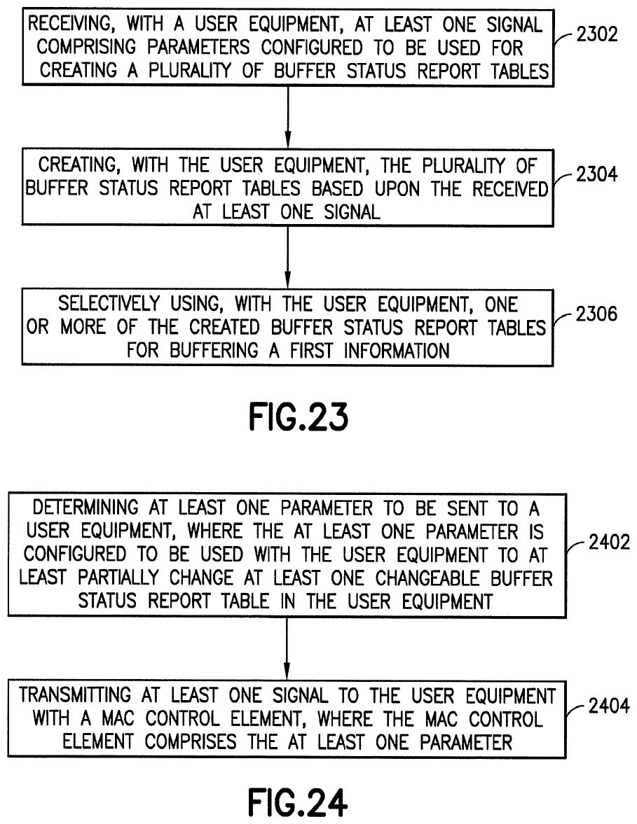

In accordance with one example embodiment, a method is provided as illustrated with FIG. 23 comprising: receiving, with a user equipment, at least one signal comprising parameters configured to be used for creating a plurality of buffer status report tables as indicated by block 2302; creating, with the user equipment, the plurality of buffer status report tables based upon the received at least one signal as indicated by block 2304; and selectively using, with the user equipment, one or more of the created buffer status report tables for buffering a first information as indicated by block 2306. The creating of the plurality of buffer status report tables may comprise creating at least one changeable buffer status report table. The creating of the plurality of buffer status report tables may comprise the received at least one signal including information configured to be used for partially or entirely changing the at least one changeable buffer status report table; and the selectively using of the one or more created buffer status report tables comprises changing at least one of the changeable buffer status report tables based upon the received information. The parameters may be configured to be used to change, in at least one of the buffer status report tables: at least one value in the buffer status report table, or a size of the buffer status report table, or a shape of values relative to one another in the buffer status report table. The parameters comprise information related to at least one of: a size of the changeable buffer status report table, a minimum value for a bin of the changeable buffer status report table, a maximum value for a bin of the changeable buffer status report table, a bin value pattern for the changeable buffer status report table, a value distribution shape for the changeable buffer status report table, whether the changeable buffer status report table is linear, whether the changeable buffer status report table is exponential. The at least one signal may comprise a BSR-CONFIG message received from a base station. The changeable buffer status report table may comprise a plurality of bins, and where the at least one memory and the computer program code are configured to, with the at least one processor, cause the apparatus to create the changeable buffer status report table such that a value in at least one of the bins is configured to be changed without changing a value in at least one other one of the bins. The at least one memory and the computer program code may be configured to, with the at least one processor, cause the apparatus to perform receiving a MAC control element with further information configured to be used to partially change the changeable buffer status report table.

In accordance with one example embodiment, a non-transitory program storage device may be provided readable by an apparatus, tangibly embodying a program of instructions executable with the apparatus for performing operations, the operations comprising: receiving at least one signal comprising parameters configured to be used for creating a plurality of buffer status report tables; creating the plurality of buffer status report tables based upon the received at least one signal; and selectively using one or more of the created buffer status report tables for buffering a first information.

In accordance with one example embodiment, an apparatus is provided comprising: means for receiving at least one signal comprising parameters configured to be used for creating a plurality of buffer status report tables; means for creating the plurality of buffer status report tables based upon the received at least one signal; and means for selectively using one or more of the created buffer status report tables for buffering a first information.

In accordance with one example embodiment, an apparatus is provided comprising: at least one processor; and at least one non-transitory memory including computer program code, the at least one memory and the computer program code configured to, with the at least one processor, cause the apparatus to perform: transmitting a signal to a user equipment over a MAC control element with information configured to be used to partially or entirely change a changeable buffer status report table in the user equipment. The at least one memory and the computer program code may be configured to, with the at least one processor, cause the apparatus to perform determining that another changeable buffer status report table in the apparatus is to be changed. The information may be configured to be used to only partially change the changeable buffer status report table in the user equipment. The information may be configured to be used to change at least one parameter defining the changeable buffer status report table in the user equipment. The information may be configured to trigger re-calculation of the changeable buffer status report table in the user equipment.

In accordance with one example embodiment, a method is provided as illustrated with FIG. 24 comprising: determining at least one parameter to be sent to a user equipment, where the at least one parameter is configured to be used with the user equipment to at least partially change at least one changeable buffer status report table in the user equipment as indicated by block 2402; and transmitting at least one signal to the user equipment with a MAC control element, where the MAC control element comprises the at least one parameter as indicated by block 2402. The method may further comprise determining that another changeable buffer status report table in the apparatus is to be changed. The information may be configured to be used to only partially change the changeable buffer status report table in the user equipment. The at least one parameter may at least partially define the changeable buffer status report table in the user equipment. The information may be configured to trigger re-calculation of the changeable buffer status report table by the user equipment.

In accordance with one example embodiment, a non-transitory program storage device may be provided readable by an apparatus, tangibly embodying a program of instructions executable with the apparatus for performing operations, the operations comprising: determining at least one parameter to be sent to a user equipment, where the at least one parameter is configured to be used with the user equipment to at least partially change at least one changeable buffer status report table in the user equipment; and transmitting at least one signal to the user equipment with a MAC control element, where the MAC control element comprises the at least one parameter.

In accordance with one example embodiment, an apparatus is provided comprising: means for determining at least one parameter to be sent to a user equipment, where the at least one parameter is configured to be used with the user equipment to at least partially change at least one changeable buffer status report table in the user equipment; and means for transmitting at least one signal to the user equipment with a MAC control element, where the MAC control element comprises the at least one parameter.

In accordance with one example embodiment, an apparatus is provided comprising: at least one processor; and at least one non-transitory memory including computer program code, the at least one memory and the computer program code configured to, with the at least one processor, cause the apparatus to perform: receiving protocol data unit session information; based, at least partially, on the received data unit session information, determining a plurality of parameters, where at least one of the parameters is configured to be used to at least partially determine a bin pattern for a changeable buffer status report table; and using the plurality of parameters to create the changeable buffer status report table.

The plurality of parameters may be configured to be used to at least partially determine a bin pattern comprising at least one of: a size of the changeable buffer status report table, a minimum value for a bin of the changeable buffer status report table, a maximum value for a bin of the changeable buffer status report table, a bin value pattern for the changeable buffer status report table, a value distribution shape for the changeable buffer status report table, whether the changeable buffer status report table is linear, whether the changeable buffer status report table is exponential. The at least one memory and the computer program code may be configured to, with the at least one processor, cause the apparatus to perform: sending the plurality of parameters to a user equipment, where the plurality of parameters are configured to at least partially cause the user equipment to create a same copy of the changeable buffer status report table. The at least one memory and the computer program code may be configured to, with the at least one processor, cause the apparatus to perform: transmitting at least one signal to the user equipment with a MAC control element, where the MAC control element comprises a change for at least one of the plurality of parameters.

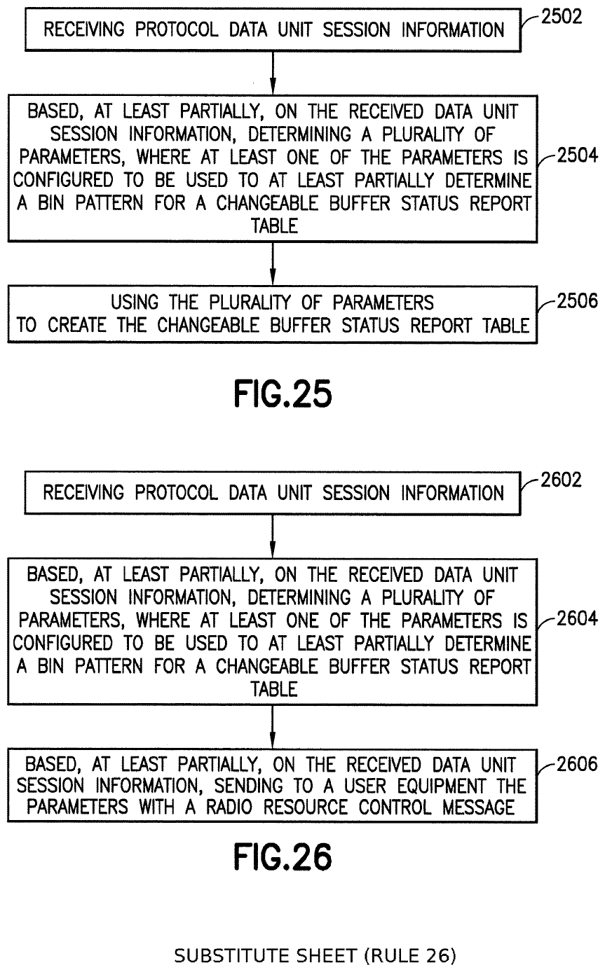

In accordance with one example embodiment, a method is provided as illustrated with FIG. 25 comprising: receiving protocol data unit session information as indicated by block 2502; based, at least partially, on the received data unit session information, determining a plurality of parameters, where at least one of the parameters is configured to be used to at least partially determine a bin pattern for a changeable buffer status report table as indicated by block 2504; and using the plurality of parameters to create the changeable buffer status report table as indicated by block 2506. The method may further comprise sending the plurality of parameters to a user equipment, where the plurality of parameters are configured to at least partially cause the user equipment to create a same copy of the changeable buffer status report table. The method may further comprise transmitting at least one signal to the user equipment with a MAC control element, where the MAC control element comprises a change for at least one of the plurality of parameters.

In accordance with one example embodiment, a non-transitory program storage device is provided readable by an apparatus, tangibly embodying a program of instructions executable with the apparatus for performing operations, the operations comprising: receiving protocol data unit session information; based, at least partially, on the received data unit session information, determining of a plurality parameters; where at least one of the parameters is configured to be used to at least partially determine a bin pattern for a changeable buffer status report table; and using the plurality of parameters to create the changeable buffer status report table.

In accordance with one example embodiment, an apparatus is provided comprising: means for receiving protocol data unit session information; means for based, at least partially, on the received data unit session information, determining a plurality of parameters, where at least one of the parameters is configured to be used to at least partially determine a bin pattern for a changeable buffer status report table; and means for using the plurality of parameters to create the changeable buffer status report table.

In accordance with one example embodiment, an apparatus is provided comprising: at least one processor; and at least one non-transitory memory including computer program code, the at least one memory and the computer program code configured to, with the at least one processor, cause the apparatus to perform: receiving protocol data unit session information; based, at least partially, on the received data unit session information, determining a plurality of parameters, where at least one of the parameters is configured to be used to at least partially determine a bin pattern for a changeable buffer status report table; and based, at least partially, on the received data unit session information, sending to a user equipment the parameters with a radio resource control message.

The plurality of parameters may be configured to be used to at least partially determine a bin pattern comprising at least one of: a size of the changeable buffer status report table, a minimum value for a bin of the changeable buffer status report table, a maximum value for a bin of the changeable buffer status report table, a bin value pattern for the changeable buffer status report table, a value distribution shape for the changeable buffer status report table, whether the changeable buffer status report table is linear, or whether the changeable buffer status report table is exponential. The at least one memory and the computer program code may be configured to, with the at least one processor, cause the apparatus to perform: transmitting at least one signal to the user equipment with a MAC control element, where the MAC control element comprises a change for at least one of the plurality of parameters. The at least one memory and the computer program code may be configured to, with the at least one processor, cause the apparatus to perform: using the plurality of parameters to create a same copy of the changeable buffer status report table in the apparatus; and using the change, which was transmitted with the at least one signal, to partially changed the copy of the changeable buffer status report table in the apparatus. The at least one memory and the computer program code may be configured to, with the at least one processor, cause the apparatus to perform: using the plurality of parameters to create a copy of the changeable buffer status report table in the apparatus.

In accordance with one example embodiment, a method is provided as illustrated with FIG. 26 comprising: receiving protocol data unit session information as indicated by block 2602; based, at least partially, on the received data unit session information, determining a plurality of parameters, where at least one of the parameters is configured to be used to at least partially determine a bin pattern for a changeable buffer status report table as indicated by block 2604; and based, at least partially, on the received data unit session information, sending to a user equipment the parameters with a radio resource control message as indicated by block 2606.

The plurality of parameters may be configured to be used to at least partially determine a bin pattern comprising at least one of: a size of the changeable buffer status report table, a minimum value for a bin of the changeable buffer status report table, a maximum value for a bin of the changeable buffer status report table, a bin value pattern for the changeable buffer status report table, a value distribution shape for the changeable buffer status report table, whether the changeable buffer status report table is linear, or whether the changeable buffer status report table is exponential. The method may further comprise transmitting at least one signal to the user equipment with a MAC control element, where the MAC control element comprises a change for at least one of the plurality of parameters. The method may further comprise: using the plurality of parameters to create a same copy of the changeable buffer status report table in the apparatus; and using the change, which was transmitted with the at least one signal, to partially changed the copy of the changeable buffer status report table in the apparatus. The method may further comprise using the plurality of parameters to create a copy of the changeable buffer status report table in the apparatus.

In accordance with one example embodiment, a non-transitory program storage device is provided readable by an apparatus, tangibly embodying a program of instructions executable with the apparatus for performing operations, the operations comprising: receiving protocol data unit session information; based, at least partially, on the received data unit session information, determining a plurality of parameters, where at least one of the parameters is configured to be used to at least partially determine a bin pattern for a changeable buffer status report table; and based, at least partially, on the received data unit session information, sending to a user equipment the parameters with a radio resource control message.

In accordance with one example embodiment, an apparatus is provided comprising: means for receiving protocol data unit session information; means for, based at least partially on the received data unit session information, determining a plurality of parameters, where at least one of the parameters is configured to be used to at least partially determine a bin pattern for a changeable buffer status report table; and means for, based at least partially on the received data unit session information, sending to a user equipment the parameters with a radio resource control message.

In accordance with one example embodiment, an apparatus is provided comprising: at least one processor; and at least one non-transitory memory including computer program code, the at least one memory and the computer program code configured to, with the at least one processor, cause the apparatus to perform: receiving a signal from a user equipment indicating that a changeable buffer status report table does not meet an accuracy requirement; and based upon the receiving of the signal, sending information to the user equipment configured for changing the changeable buffer status report table in the user equipment.

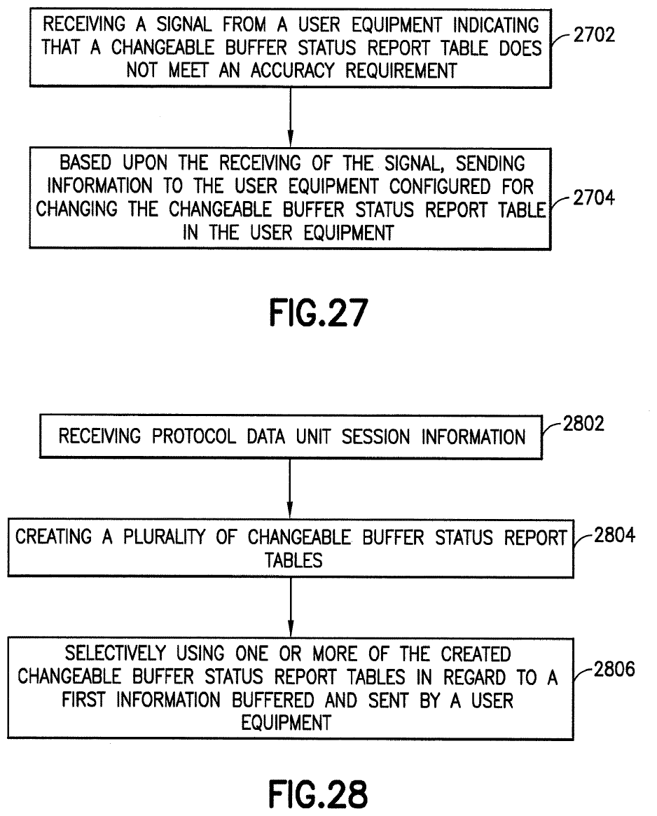

In accordance with one example embodiment, a method is provided as illustrated with FIG. 27 comprising: receiving a signal from a user equipment indicating that a changeable buffer status report table does not meet an accuracy requirement; and based upon the receiving of the signal, sending information to the user equipment configured for changing the changeable buffer status report table in the user equipment.

In accordance with one example embodiment, a non-transitory program storage device is provided readable by an apparatus, tangibly embodying a program of instructions executable with the apparatus for performing operations, the operations comprising: receiving a signal from a user equipment indicating that a changeable buffer status report table does not meet an accuracy requirement; and based upon the receiving of the signal, sending information to the user equipment configured for changing the changeable buffer status report table in the user equipment.

In accordance with one example embodiment, an apparatus is provided comprising: means for receiving a signal from a user equipment indicating that a changeable buffer status report table does not meet an accuracy requirement; means for, based upon the receiving of the signal, sending information to the user equipment configured for changing the changeable buffer status report table in the user equipment.

In accordance with one example embodiment, an apparatus is provided comprising: at least one processor; and at least one non-transitory memory including computer program code, the at least one memory and the computer program code configured to, with the at least one processor, cause the apparatus to perform: receiving protocol data unit session information; creating a plurality of changeable buffer status report tables; and selectively using one or more of the created changeable buffer status report tables in regard to a first information buffered and sent by a user equipment.

In accordance with one example embodiment, a method is provided as illustrated with FIG. 28 comprising: receiving protocol data unit session information as indicated by block 2802; creating a plurality of changeable buffer status report tables as indicated by block 2804; and selectively using one or more of the created changeable buffer status report tables in regard to a first information buffered and sent by a user equipment as indicated by block 2806.

In accordance with one example embodiment, a non-transitory program storage device is provided readable by an apparatus, tangibly embodying a program of instructions executable with the apparatus for performing operations, the operations comprising: receiving protocol data unit session information; creating a plurality of changeable buffer status report tables; and selectively using one or more of the created changeable buffer status report tables in regard to a first information buffered and sent by a user equipment.

In accordance with one example embodiment, an apparatus is provided comprising: means for receiving protocol data unit session information; means for creating a plurality of changeable buffer status report tables; and means for selectively using one or more of the created changeable buffer status report tables in regard to a first information buffered and sent by a user equipment.

In accordance with one example embodiment, an apparatus is provided comprising: at least one processor; and at least one non-transitory memory including computer program code, the at least one memory and the computer program code configured to, with the at least one processor, cause the apparatus to perform: selecting a plurality of buffer status reports so that the sum of buffer sizes reported for the plurality of buffer status reports is more accurate than the buffer size indicated by a single one of the buffer status reports.

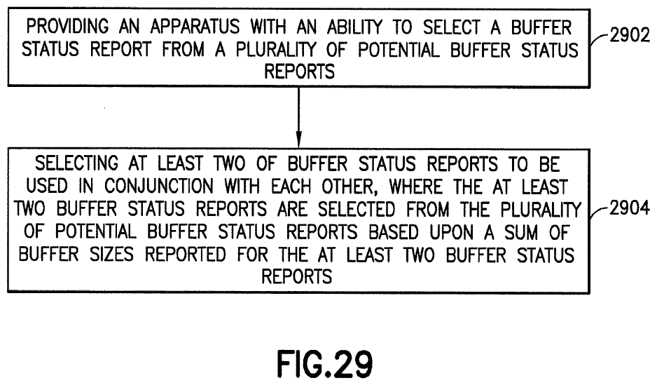

In accordance with one example embodiment, a method is provided as illustrated with FIG. 29 comprising: providing an apparatus with an ability to select a buffer status report from a plurality of potential buffer status reports; and selecting at least two of buffer status reports to be used in conjunction with each other, where the at least two buffer status reports are selected from the plurality of potential buffer status reports based upon a sum of buffer sizes reported for the at least two buffer status reports.

In accordance with one example embodiment, a non-transitory program storage device is provided readable by an apparatus, tangibly embodying a program of instructions executable with the apparatus for performing operations, the operations comprising: providing an apparatus with an ability to select a buffer status report from a plurality of potential buffer status reports; and selecting at least two of buffer status reports to be used in conjunction with each other, where the at least two buffer status reports are selected from the plurality of potential buffer status reports based upon a sum of buffer sizes reported for the at least two buffer status reports.

In accordance with one example embodiment, an apparatus is provided comprising: means for providing an apparatus with an ability to select a buffer status report from a plurality of potential buffer status reports; and means for selecting at least two of buffer status reports to be used in conjunction with each other, where the at least two buffer status reports are selected from the plurality of potential buffer status reports based upon a sum of buffer sizes reported for the at least two buffer status reports.

In accordance with one example embodiment, an apparatus is provided comprising: at least one processor; and at least one non-transitory memory including computer program code, the at least one memory and the computer program code configured to, with the at least one processor, cause the apparatus to perform: receiving a signal comprising information configured for generating a changeable buffer status report table; and generating the changeable buffer status report table based upon the received information.

In accordance with one example embodiment, an apparatus is provided comprising: An apparatus comprising: at least one processor; and at least one non-transitory memory including computer program code, the at least one memory and the computer program code configured to, with the at least one processor, cause the apparatus to perform: receiving protocol data unit session information, where the protocol data unit session information comprises an indication for a changeable buffer status report table; based, at least partially, on the received data unit session information, creating the changeable buffer status report table; and sending the created changeable buffer status report table to a user equipment.

In accordance with one example embodiment, an apparatus is provided comprising: at least one processor; and at least one non-transitory memory including computer program code, the at least one memory and the computer program code configured to, with the at least one processor, cause the apparatus to perform: receiving protocol data unit session information, where the protocol data unit session information comprises an indication for a changeable buffer status report table; and based, at least partially, on the received data unit session information, sending to a user equipment parameters, where the parameters are configured to be used by the user equipment to create the changeable buffer status report table.

With features as described herein, the new changeable BSR table may already have been decided for, and is subsequently configured with one or more parameters over RRC and in use. The new MAC CE in this case may be used to change one or more of the parameters defining the table; thereby triggering table re-calculation.

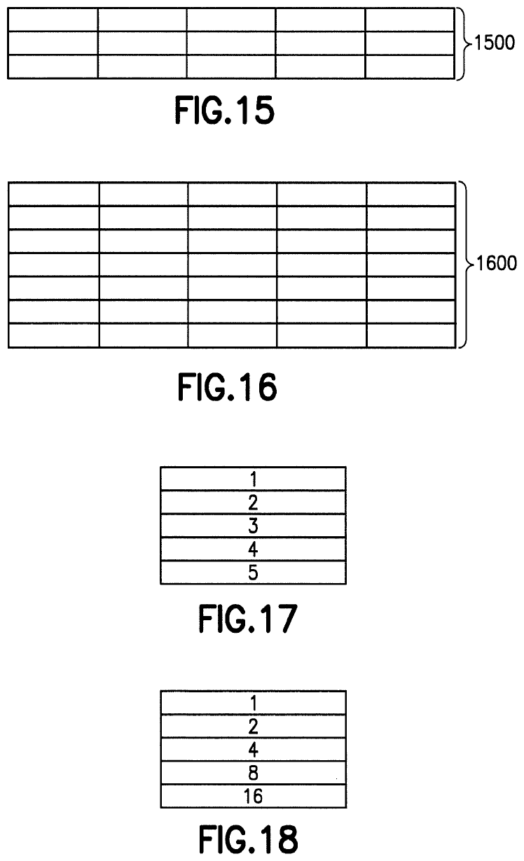

A bin pattern may comprise, for example, a predefined number of bins distribution across a packet size range bounded by MIN/MAX. As an example, FIG. 15 shows an example smaller size 1500 bin pattern (only 3 rows of bins) versus FIG. 16 which shows an example relatively larger size 1600 bin pattern (7 rows of bins). Similarly, FIG. 17 is shown to illustrate a linear bin pattern or shape (values increasing 1-6 in a linear pattern) and FIG. 18 is shown to illustrate a non-linear bin pattern or shape (the values in the bins or fields increasing 1, 2, 4, 8, 16). With features as described herein, a lowerbound and an upperbound may be used to establish a size for a BSR table. The lowerbound and the upperbound may be used in addition to a minimum value (Min) in the bins and maximum value (Max) in the bins. Min and Max are not optimal by themselves. It has been found that more information may be used to better fit to the traffic; such as use of the size of the table with a lowerbound and an upperbound as noted above. Another features may employ use of traffic statistics knowledge. In addition to Min and Max, an example embodiment may use standard deviation and mean of the traffic. The can also be computed from Min/Max assuming no distribution skewing for example. These can be signaled in the PDU session set up based on XR application signaling or based on statistics observed by the gNB. With features as described herein, Min/Max and certain statistical knowledge of the traffic; obtained either by direct signaling or monitoring.

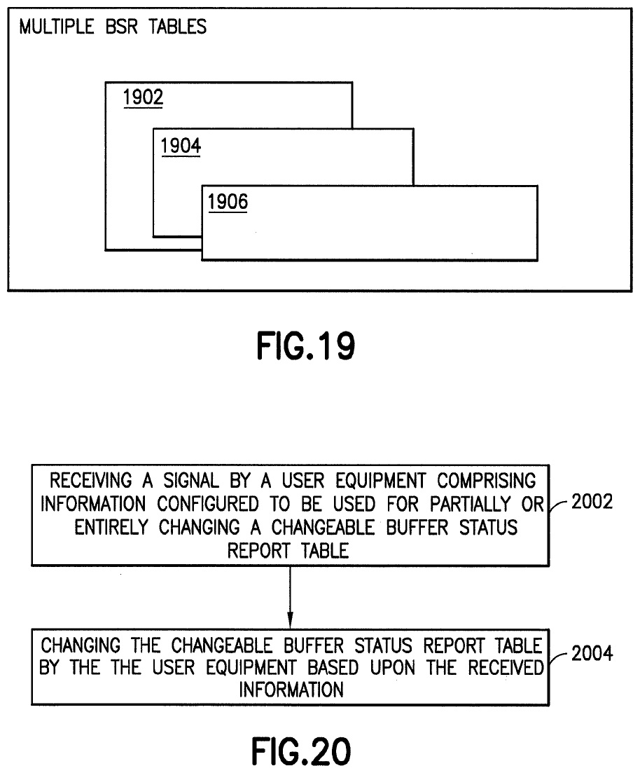

FIG. 19 is a diagram illustrating that the UE may comprise multiple BSR tables which have different sizes and/or shapes such as 1902, 1904 and 1906. The UE may be configured to select one or more of the different size/shape tables to use as noted above.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

1.-111. (canceled)

112. An apparatus comprising:
at least one processor; and
at least one non-transitory memory including computer program code,
the at least one memory and the computer program code configured to, with the at least one processor, cause the apparatus to perform:
receiving a signal comprising information configured to be used for partially or entirely changing a changeable buffer status report table; and
changing the changeable buffer status report table based upon the received information.

113. The apparatus as claimed in claim 112, where the information is configured to be used to only partially change the changeable buffer status report table.

114. The apparatus as claimed in claim 112, where the information comprises parameters configured to be used to change at least one value in the changeable buffer status report table or a size of the changeable buffer status report table or a shape of values in the changeable buffer status report table.

115. The apparatus as claimed in claim 112, where the parameters comprise information related to at least one of:
a size of the changeable buffer status report table,
a minimum value for a bin of the changeable buffer status report table,
a maximum value for a bin of the changeable buffer status report table,
a bin value pattern for the changeable buffer status report table,
a value distribution shape for the changeable buffer status report table,
whether the changeable buffer status report table is linear,
whether the changeable buffer status report table is exponential.

116. The apparatus as claimed in in claim 112, where the signal comprises a BSR-CONFIG signal received from a base station.

117. The apparatus as claimed in claim 112, where the changeable buffer status report table comprises a plurality of bins, and where the at least one memory and the computer program code are configured to, with the at least one processor, cause the apparatus to create the changeable buffer status report table such that a value in at least one of the bins is configured to be changed without changing a value in at least one other one of the bins.

118. The apparatus as claimed in claim 112, where the at least one memory and the computer program code are configured to, with the at least one processor, cause the apparatus to perform receiving a MAC control element with further information configured to be used to partially change the changeable buffer status report table.

119. The apparatus as claimed in claim 112, where the signal comprises a MAC control element message.

120. An apparatus comprising:
at least one processor; and
at least one non-transitory memory including computer program code,
the at least one memory and the computer program code configured to, with the at least one processor, cause the apparatus to perform:
receiving a signal comprising parameters configured to be used for creating a changeable buffer status report table, where at least one of the parameters is configured to be used to at least partially determine a bin pattern for the changeable buffer status report table; and
creating the changeable buffer status report table based, at least partially, upon the received signal.

121. The apparatus as claimed in claim 120, where the creating of the changeable buffer status report table comprises creating the changeable buffer status report table such that a portion of the changeable buffer status report table is configured to be changed without changing another portion of the changeable buffer status report table.

122. The apparatus as claimed in claim 120, where the parameters are configured to be used to establish at least one value in the changeable buffer status report table or a size of the changeable buffer status report table or a shape of values relative to one another in the changeable buffer status report table.

123. The apparatus as claimed in claim 120, where the parameters comprise information related to at least one of:
a size of the changeable buffer status report table,
a minimum value for a bin of the changeable buffer status report table,
a maximum value for a bin of the changeable buffer status report table,
a bin value pattern for the changeable buffer status report table,
a value distribution shape for the changeable buffer status report table,
whether the changeable buffer status report table is linear, or
whether the changeable buffer status report table is exponential.

124. The apparatus as claimed in claim 120, where the signal comprises a BSR-CONFIG signal received from a base station.

125. The apparatus as claimed in claim 120, where the changeable buffer status report table comprises a plurality of bins, and where the at least one memory and the computer program code are configured to, with the at least one processor, cause the apparatus to create the changeable buffer status report table such that a value in at least one of the bins is configured to be changed without changing a value in at least one other one of the bins.

126. The apparatus as claimed in claim 120, where the at least one memory and the computer program code are configured to, with the at least one processor, cause the apparatus to perform receiving a MAC control element with further information configured to be used to partially change the changeable buffer status report table.

127. An apparatus comprising:
at least one processor; and
at least one non-transitory memory including computer program code,
the at least one memory and the computer program code configured to, with the at least one processor, cause the apparatus to perform:
determining that a changeable buffer status report table has an accuracy below a predetermined threshold; and
based upon the determining that the changeable buffer status report table has an accuracy below the predetermined threshold, transmitting information to indicate that the changeable buffer status report table has the accuracy below the predetermined threshold.

128. The apparatus as claimed in claim 127, where the transmitting of the information to indicate that the changeable buffer status report table has an accuracy below the predetermined threshold comprises a MAC control element transmitted by the apparatus to a base station.

129. The apparatus as claimed in claim 127, where the transmitting of the information to indicate that the changeable buffer status report table has an accuracy below the predetermined threshold comprises a bit in a buffer status report MAC control element.

130. The apparatus as claimed in claim 127, where the threshold is one of: a threshold received by the apparatus or a threshold configured by the apparatus.

131. The apparatus as claimed in claim 127, where at least one of:
the threshold is in regard to a transmission time interval (TTI), and/or
the transmitted information is configured to trigger sending of further information to partially change the changeable buffer status report table.
